(19) United States
(12) Patent Application Publication
(10) Pub. No.: US 2021/0341941 A1
(43) Pub. Date: Nov. 4, 2021

(54) Mapping System and Method

(71) Applicant: Optimus Ride, Inc., Boston, MA (US)

(72) Inventors: Sertac Karaman, Boston, MA (US); Albert Huang, Sunnyvale, CA (US)

(21) Appl. No.: 17/307,477

(22) Filed: May 4, 2021

Related U.S. Application Data
(60) Provisional application No. 63/019,890, filed on May 4, 2020.

(51) Int. Cl. G05D 1/02; G05D 1/00

(52) U.S. Cl. CPC G05D 1/0274; G05D 2201/0213; G05D 1/0088; G05D 1/0214

(57) ABSTRACT

A method, computer program product, and computing system for receiving metric data that is based, at least in part, upon sensor data generated by various sensors of an autonomous vehicle; and processing the metric data to generate a semantic understanding of the autonomous vehicle.

### RELATED APPLICATIONS(S)

This application claims the benefit of U.S. Provisional Application No. 63/019,890 filed on 4 May 2020, the entire contents of which are incorporated herein by reference.

### TECHNICAL FIELD

This disclosure relates to data mapping and, more particularly, to data mapping for use with autonomous vehicles.

### BACKGROUND

As transportation moves towards autonomous (i.e., driverless) vehicles, the manufactures and designers of these autonomous vehicle must define contingencies that occur in the event of a failure of one or more of the systems within these autonomous vehicles.

As is known, autonomous vehicles contain multiple electronic control units (ECUs), wherein each of these ECUs may perform a specific function. For example, these various ECUs may calculate safe trajectories for the vehicle (e.g., for navigating the vehicle to its intended destination) and may provide control signals to the vehicle's actuators, propulsions systems and braking systems. Typically, one ECU (e.g., an Autonomy Control Unit) may be responsible for planning and calculating a trajectory for the vehicle, and may provide commands to other ECUs that may cause the vehicle to move (e.g., by controlling steering, braking, and powertrain ECUs).

As would be expected, such autonomous vehicles generate numbers-driven data. For example, objects proximate the autonomous vehicle may be tracked . . . distances may be measured . . . velocities may be determined . . . and angles may be monitored. Unfortunately, such numbers-driven data does not present well to humans.

### SUMMARY OF DISCLOSURE

Concept 1

In one implementation, a computer-implement method is executed on a computing device and includes: receiving metric data that is based, at least in part, upon sensor data generated by various sensors of an autonomous vehicle; and processing the metric data to generate a semantic understanding of the autonomous vehicle.

One or more of the following features may be included. Processing the metric data to generate a semantic understanding of the autonomous vehicle may include: generating a spatial understanding with respect to the autonomous vehicle. Processing the metric data to generate a semantic understanding of the autonomous vehicle may include: generating a temporal understanding with respect to the autonomous vehicle. Processing the metric data to generate a semantic understanding of the autonomous vehicle may include: creating/updating a semantic understanding of the autonomous vehicle and the state of the surroundings of the autonomous vehicle. thus generating a semantic view. Processing the metric data to generate a semantic understanding of the autonomous vehicle may include: processing the semantic understanding to make complex inferences relating to dynamic agents and static infrastructure in the environment, thus generating semantic inferences. Processing the metric data to generate a semantic understanding of the autonomous vehicle may include: processing the semantic understanding and the semantic inferences to make complex behavioral decisions to fulfill the navigational objectives of the autonomous vehicle. The semantic view may include one or more of: a static infrastructure semantic view having a set of nodes that includes all static infrastructure elements; and a dynamic agent semantic view having a set of nodes that includes: all nodes of the static infrastructure semantic view, and nodes for all dynamic agents.

In another implementation, a computer program product resides on a computer readable medium and has a plurality of instructions stored on it. When executed by a processor, the instructions cause the processor to perform operations including: receiving metric data that is based, at least in part, upon sensor data generated by various sensors of an autonomous vehicle; and processing the metric data to generate a semantic understanding of the autonomous vehicle.

One or more of the following features may be included. Processing the metric data to generate a semantic understanding of the autonomous vehicle may include: generating a spatial understanding with respect to the autonomous vehicle. Processing the metric data to generate a semantic understanding of the autonomous vehicle may include: generating a temporal understanding with respect to the autonomous vehicle. Processing the metric data to generate a semantic understanding of the autonomous vehicle may include: creating/updating a semantic understanding of the autonomous vehicle and the state of the surroundings of the autonomous vehicle. thus generating a semantic view. Processing the metric data to generate a semantic understanding of the autonomous vehicle may include: processing the semantic understanding to make complex inferences relating to dynamic agents and static infrastructure in the environment, thus generating semantic inferences. Processing the metric data to generate a semantic understanding of the autonomous vehicle may include: processing the semantic understanding and the semantic inferences to make complex behavioral decisions to fulfill the navigational objectives of the autonomous vehicle. The semantic view may include one or more of: a static infrastructure semantic view having a set of nodes that includes all static infrastructure elements; and a dynamic agent semantic view having a set of nodes that includes: all nodes of the static infrastructure semantic view, and nodes for all dynamic agents.

In another implementation, a computing system includes a processor and memory is configured to perform operations including: receiving metric data that is based, at least in part, upon sensor data generated by various sensors of an autonomous vehicle; and processing the metric data to generate a semantic understanding of the autonomous vehicle.

One or more of the following features may be included. Processing the metric data to generate a semantic understanding of the autonomous vehicle may include: generating a spatial understanding with respect to the autonomous vehicle. Processing the metric data to generate a semantic understanding of the autonomous vehicle may include: generating a temporal understanding with respect to the autonomous vehicle. Processing the metric data to generate a semantic understanding of the autonomous vehicle may include: creating/updating a semantic understanding of the autonomous vehicle and the state of the surroundings of the autonomous vehicle. thus generating a semantic view. Processing the metric data to generate a semantic understanding of the autonomous vehicle may include: processing the semantic understanding to make complex inferences relating to dynamic agents and static infrastructure in the environment, thus generating semantic inferences. Processing the metric data to generate a semantic understanding of the autonomous vehicle may include: processing the semantic understanding and the semantic inferences to make complex behavioral decisions to fulfill the navigational objectives of the autonomous vehicle. The semantic view may include one or more of: a static infrastructure semantic view having a set of nodes that includes all static infrastructure elements; and a dynamic agent semantic view having a set of nodes that includes: all nodes of the static infrastructure semantic view, and nodes for all dynamic agents.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an autonomous vehicle according to an embodiment of the present disclosure;

FIG. 2A is a diagrammatic view of one embodiment of the various systems included within the autonomous vehicle of FIG. 1 according to an embodiment of the present disclosure;

FIG. 2B is a diagrammatic view of another embodiment of the various systems included within the autonomous vehicle of FIG. 1 according to an embodiment of the present disclosure;

FIG. 3 is a diagrammatic view of another embodiment of the various systems included within the autonomous vehicle of FIG. 1 according to an embodiment of the present disclosure;

FIG. 4 is a diagrammatic view of a plurality of vehicle monitors according to an embodiment of the present disclosure;

FIG. 5 is a diagrammatic view of an environment encountered by the autonomous vehicle of FIG. 1 according to an embodiment of the present disclosure;

FIG. 6 is a flowchart of a mapping process for interacting with the environment of FIG. 5 according to an embodiment of the present disclosure.

FIGS. 7A-7C are diagrammatic views of environments encountered by the autonomous vehicle of FIG. 1 according to an embodiment of the present disclosure;

FIGS. 8A-8C are diagrammatic views of environments encountered by the autonomous vehicle of FIG. 1 according to an embodiment of the present disclosure;

FIGS. 9A-9C are semantic views of the environments of FIGS. 8A-8C according to an embodiment of the present disclosure;

FIG. 10A is a diagrammatic view of an environment encountered by the autonomous vehicle of FIG. 1 according to an embodiment of the present disclosure; and

FIG. 10B is a semantic view of the environment of FIG. 10A according to an embodiment of the present disclosure.

Like reference symbols in the various drawings indicate like elements.

### DETAILED DESCRIPTION OF THE PREFERRED EMBODIMENTS

Autonomous Vehicle Overview

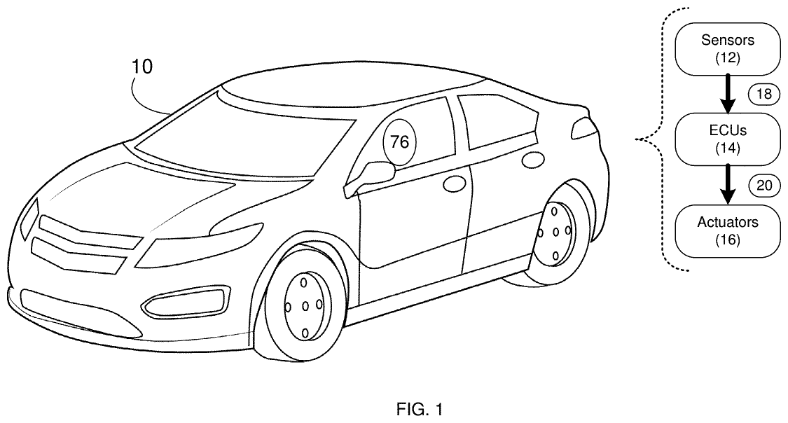

Referring to FIG. 1, there is shown autonomous vehicle 10. As is known in the art, an autonomous vehicle (e.g. autonomous vehicle 10) is a vehicle that is capable of sensing its environment and moving with little or no human input. Autonomous vehicles (e.g. autonomous vehicle 10) may combine a variety of sensor systems to perceive their surroundings, examples of which may include but are not limited to radar, computer vision, LIDAR, GPS, odometry, temperature and inertia, wherein such sensor systems may be configured to interpret lanes and markings on a roadway, street signs, stoplights, pedestrians, other vehicles, roadside objects, hazards, etc.

Autonomous vehicle 10 may include a plurality of sensors (e.g. sensors 12), a plurality of electronic control units (e.g. ECUs 14) and a plurality of actuators (e.g. actuators 16). Accordingly, sensors 12 within autonomous vehicle 10 may monitor the environment in which autonomous vehicle 10 is operating, wherein sensors 12 may provide sensor data 18 to ECUs 14. ECUs 14 may process sensor data 18 to determine the manner in which autonomous vehicle 10 should move. ECUs 14 may then provide control data 20 to actuators 16 so that autonomous vehicle 10 may move in the manner decided by ECUs 14. For example, a machine vision sensor included within sensors 12 may “read” a speed limit sign stating that the speed limit on the road on which autonomous vehicle 10 is traveling is now 35 miles an hour. This machine vision sensor included within sensors 12 may provide sensor data 18 to ECUs 14 indicating that the speed on the road on which autonomous vehicle 10 is traveling is now 35 mph. Upon receiving sensor data 18, ECUs 14 may process sensor data 18 and may determine that autonomous vehicle 10 (which is currently traveling at 45 mph) is traveling too fast and needs to slow down. Accordingly, ECUs 14 may provide control data 20 to actuators 16, wherein control data 20 may e.g. apply the brakes of autonomous vehicle 10 or eliminate any actuation signal currently being applied to the accelerator (thus allowing autonomous vehicle 10 to coast until the speed of autonomous vehicle 10 is reduced to 35 mph).

System Redundancy

As would be imagined, since autonomous vehicle 10 is being controlled by the various electronic systems included therein (e.g. sensors 12, ECUs 14 and actuators 16), the potential failure of one or more of these systems should be considered when designing autonomous vehicle 10 and appropriate contingency plans may be employed.

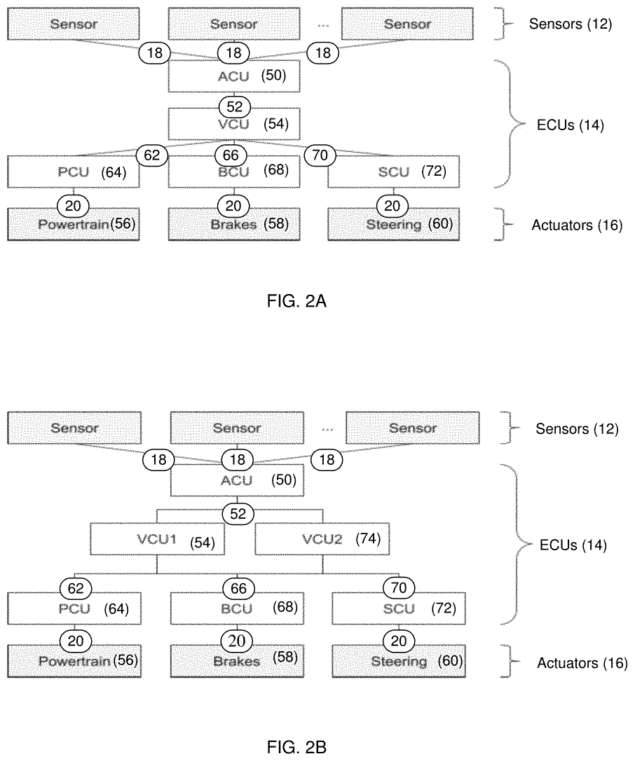

For example and referring also to FIG. 2A, the various ECUs (e.g., ECUs 14) that are included within autonomous vehicle 10 may be compartmentalized so that the responsibilities of the various ECUs (e.g., ECUs 14) may be logically grouped. For example, ECUs 14 may include autonomy control unit 50 that may receive sensor data 18 from sensors 12.

Autonomy control unit 50 may be configured to perform various functions. For example, autonomy control unit 50 may receive and process exteroceptive sensor data (e.g., sensor data 18), may estimate the position of autonomous vehicle 10 within its operating environment, may calculate a representation of the surroundings of autonomous vehicle 10, may compute safe trajectories for autonomous vehicle 10, and may command the other ECUs (in particular, a vehicle control unit) to cause autonomous vehicle 10 to execute a desired maneuver. Autonomy control unit 50 may include substantial compute power, persistent storage, and memory.

Accordingly, autonomy control unit 50 may process sensor data 18 to determine the manner in which autonomous vehicle 10 should be operating. Autonomy control unit 50 may then provide vehicle control data 52 to vehicle control unit 54, wherein vehicle control unit 54 may then process vehicle control data 52 to determine the manner in which the individual control systems (e.g. powertrain system 56, braking system 58 and steering system 60) should respond in order to achieve the trajectory defined by autonomous control unit 50 within vehicle control data 52.

Vehicle control unit 54 may be configured to control other ECUs included within autonomous vehicle 10. For example, vehicle control unit 54 may control the steering, powertrain, and brake controller units. For example, vehicle control unit 54 may provide: powertrain control signal 62 to powertrain control unit 64; braking control signal 66 to braking control unit 68; and steering control signal 70 to steering control unit 72.

Powertrain control unit 64 may process powertrain control signal 62 so that the appropriate control data (commonly represented by control data 20) may be provided to powertrain system 56. Additionally, braking control unit 68 may process braking control signal 66 so that the appropriate control data (commonly represented by control data 20) may be provided to braking system 58. Further, steering control unit 72 may process steering control signal 70 so that the appropriate control data (commonly represented by control data 20) may be provided to steering system 60.

Powertrain control unit 64 may be configured to control the transmission (not shown) and engine/traction motor (not shown) within autonomous vehicle 10; while brake control unit 68 may be configured to control the mechanical/regenerative braking system (not shown) within autonomous vehicle 10; and steering control unit 72 may be configured to control the steering column/steering rack (not shown) within autonomous vehicle 10.

Autonomy control unit 50 may be a highly complex computing system that may provide extensive processing capabilities (e.g., a workstation-class computing system with multi-core processors, discrete co-processing units, gigabytes of memory, and persistent storage). In contrast, vehicle control unit 54 may be a much simpler device that may provide processing power equivalent to the other ECUs included within autonomous vehicle 10 (e.g., a computing system having a modest microprocessor (with a CPU frequency of less than 200 megahertz), less than 1 megabyte of system memory, and no persistent storage). Due to these simpler designs, vehicle control unit 54 may have greater reliability and durability than autonomy control unit 50.

To further enhance redundancy and reliability, one or more of the ECUs (ECUs 14) included within autonomous vehicle 10 may be configured in a redundant fashion. For example and referring also to FIG. 2B, there is shown one implementation of ECUs 14 wherein a plurality of vehicle control units are utilized. For example, this particular implementation is shown to include two vehicle control units, namely a first vehicle control unit (e.g., vehicle control unit 54) and a second vehicle control unit (e.g., vehicle control unit 74).

In this particular configuration, the two vehicle control units (e.g. vehicle control units 54, 74) may be configured in various ways. For example, the two vehicle control units (e.g. vehicle control units 54, 74) may be configured in an active-passive configuration, wherein e.g. vehicle control unit 54 performs the active role of processing vehicle control data 52 while vehicle control unit 74 assumes a passive role and is essentially in standby mode. In the event of a failure of vehicle control unit 54, vehicle control unit 74 may transition from a passive role to an active role and assume the role of processing vehicle control data 52. Alternatively, the two vehicle control units (e.g. vehicle control units 54, 74) may be configured in an active-active configuration, wherein e.g. both vehicle control unit 52 and vehicle control unit 74 perform the active role of processing vehicle control data 54 (e.g. divvying up the workload), wherein in the event of a failure of either vehicle control unit 54 or vehicle control unit 74, the surviving vehicle control unit may process all of vehicle control data 52.

While FIG. 2B illustrates one example of the manner in which the various ECUs (e.g. ECUs 14) included within autonomous vehicle 10 may be configured in a redundant fashion, this is for illustrative purposes only and is not intended to be a limitation of this disclosure, as other configurations are possible and are considered to be within the scope of this disclosure. For example, autonomous control unit 50 may be configured in a redundant fashion, wherein a second autonomous control unit (not shown) is included within autonomous vehicle 10 and is configured in an active-passive or active-active fashion. Further, it is foreseeable that one or more of the sensors (e.g., sensors 12) and/or one or more of the actuators (e.g. actuators 16) may be configured in a redundant fashion. Accordingly, it is understood that the level of redundancy achievable with respect to autonomous vehicle 10 may only be limited by the design criteria and budget constraints of autonomous vehicle 10.

Autonomy Computational Subsystems

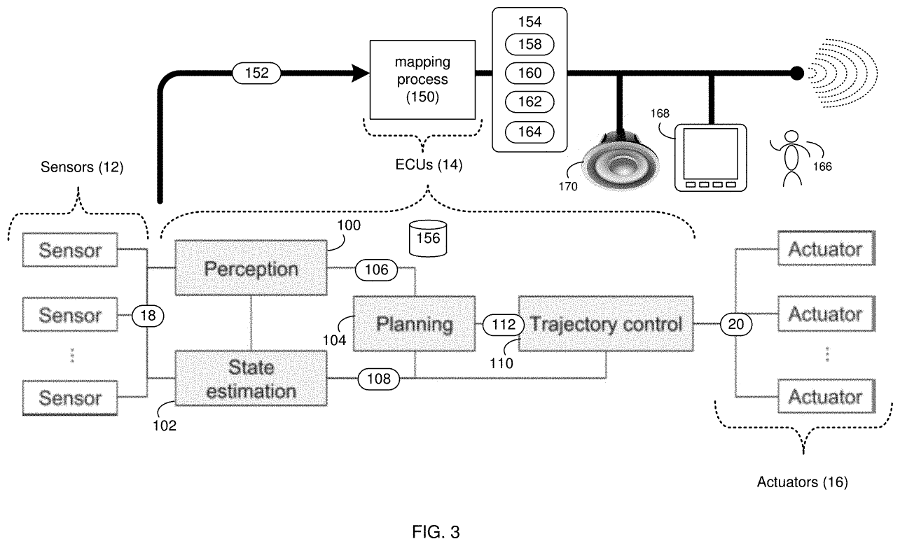

Referring also to FIG. 3, the various ECUs of autonomous vehicle 10 may be grouped/arranged/configured to effectuate various functionalities.

For example, one or more of ECUs 14 may be configured to effectuate/form perception subsystem 100. wherein perception subsystem 100 may be configured to process data from onboard sensors (e.g., sensor data 18) to calculate concise representations of objects of interest near autonomous vehicle 10 (examples of which may include but are not limited to other vehicles, pedestrians, traffic signals, traffic signs, road markers, hazards, etc.) and to identify environmental features that may assist in determining the location of autonomous vehicle 10. Further, one or more of ECUs 14 may be configured to effectuate/form state estimation subsystem 102, wherein state estimation subsystem 102 may be configured to process data from onboard sensors (e.g., sensor data 18) to estimate the position, orientation, and velocity of autonomous vehicle 10 within its operating environment. Additionally, one or more of ECUs 14 may be configured to effectuate/form planning subsystem 104, wherein planning subsystem 104 may be configured to calculate a desired vehicle trajectory (using perception output 106 and state estimation output 108). Further still, one or more of ECUs 14 may be configured to effectuate/form trajectory control subsystem 110, wherein trajectory control subsystem 110 uses planning output 112 and state estimation output 108 (in conjunction with feedback and/or feedforward control techniques) to calculate actuator commands (e.g., control data 20) that may cause autonomous vehicle 10 to execute its intended trajectory within it operating environment.

For redundancy purposes, the above-described subsystems may be distributed across various devices (e.g., autonomy control unit 50 and vehicle control units 54, 74). Additionally/alternatively and due to the increased computational requirements, perception subsystem 100 and planning subsystem 104 may be located almost entirely within autonomy control unit 50, which (as discussed above) has much more computational horsepower than vehicle control units 54, 74. Conversely and due to their lower computational requirements, state estimation subsystem 102 and trajectory control subsystem 110 may be: located entirely on vehicle control units 54, 74 if vehicle control units 54, 74 have the requisite computational capacity; and/or located partially on vehicle control units 54, 74 and partially on autonomy control unit 50. However, the location of state estimation subsystem 102 and trajectory control subsystem 110 may be of critical importance in the design of any contingency planning architecture, as the location of these subsystems may determine how contingency plans are calculated, transmitted, and/or executed.

Trajectory Calculation

During typical operation of autonomous vehicle 10, the autonomy subsystems described above repeatedly perform the following functionalities of:

Measuring the surrounding environment using on-board sensors (e.g. using sensors 12);

Estimating the positions, velocities, and future trajectories of surrounding vehicles, pedestrians, cyclists, other objects near autonomous vehicle 10, and environmental features useful for location determination (e.g., using perception subsystem 100);

Estimating the position, orientation, and velocity of autonomous vehicle 10 within the operating environment (e.g., using state estimation subsystem 102);

Planning a nominal trajectory for autonomous vehicle 10 to follow that brings autonomous vehicle 10 closer to the intended destination of autonomous vehicle 10 (e.g., using planning subsystem 104); and

Generating commands (e.g., control data 20) to cause autonomous vehicle 10 to execute the intended trajectory (e.g., using trajectory control subsystem 110)

During each iteration, planning subsystem 104 may calculate a trajectory that may span travel of many meters (in distance) and many seconds (in time). However, each iteration of the above-described loop may be calculated much more frequently (e.g., every ten milliseconds). Accordingly, autonomous vehicle 10 may be expected to execute only a small portion of each planned trajectory before a new trajectory is calculated (which may differ from the previously-calculated trajectories due to e.g., sensed environmental changes).

Trajectory Execution

The above-described trajectory may be represented as a parametric curve that describes the desired future path of autonomous vehicle 10. There may be two major classes of techniques for controlling autonomous vehicle 10 while executing the above-described trajectory: a) feedforward control and b) feedback control.

Under nominal conditions, a trajectory is executed using feedback control, wherein feedback trajectory control algorithms may use e.g., a kinodynamic model of autonomous vehicle 10, per-vehicle configuration parameters, and a continuously-calculated estimate of the position, orientation, and velocity of autonomous vehicle 10 to calculate the commands that are provided to the various ECUs included within autonomous vehicle 10.

Feedforward trajectory control algorithms may use a kinodynamic model of autonomous vehicle 10, per-vehicle configuration parameters, and a single estimate of the initial position, orientation, and velocity of autonomous vehicle 10 to calculate a sequence of commands that are provided to the various ECUs included within autonomous vehicle 10, wherein the sequence of commands are executed without using any real-time sensor data (e.g. from sensors 12) or other information.

To execute the above-described trajectories, autonomy control unit 50 may communicate with (and may provide commands to) the various ECUs, using vehicle control unit 54/74 as an intermediary. At each iteration of the above-described trajectory execution loop, autonomy control unit 50 may calculate steering, powertrain, and brake commands that are provided to their respective ECUs (e.g., powertrain control unit 64, braking control unit 68, and steering control unit 72; respectively), and may transmit these commands to vehicle control unit 54/74. Vehicle control unit 54/74 may then validate these commands and may relay them to the various ECUs (e.g., powertrain control unit 64, braking control unit 68, and steering control unit 72; respectively).

Vehicle Monitors

As discussed above and during typical operation of autonomous vehicle 10, the autonomy subsystems described above may repeatedly perform the following functionalities of: measuring the surrounding environment using on-board sensors (e.g. using sensors 12); estimating the positions, velocities, and future trajectories of surrounding vehicles, pedestrians, cyclists, other objects near autonomous vehicle 10, and environmental features useful for location determination (e.g., using perception subsystem 100); estimating the position, orientation, and velocity of autonomous vehicle 10 within the operating environment (e.g., using state estimation subsystem 102); planning a nominal trajectory for autonomous vehicle 10 to follow that brings autonomous vehicle 10 closer to the intended destination of autonomous vehicle 10 (e.g., using planning subsystem 104); and generating commands (e.g., control data 20) to cause autonomous vehicle 10 to execute the intended trajectory (e.g., using trajectory control subsystem 110).

The operation of autonomous vehicle 10 may be supervised by a vehicle monitor (e.g., a human vehicle monitor). Specifically and in a fashion similar to the manner in which an air traffic controller monitors the operation of one or more airplanes, a vehicle monitor may monitor the operation of one or more autonomous vehicles (e.g., autonomous vehicle 10).

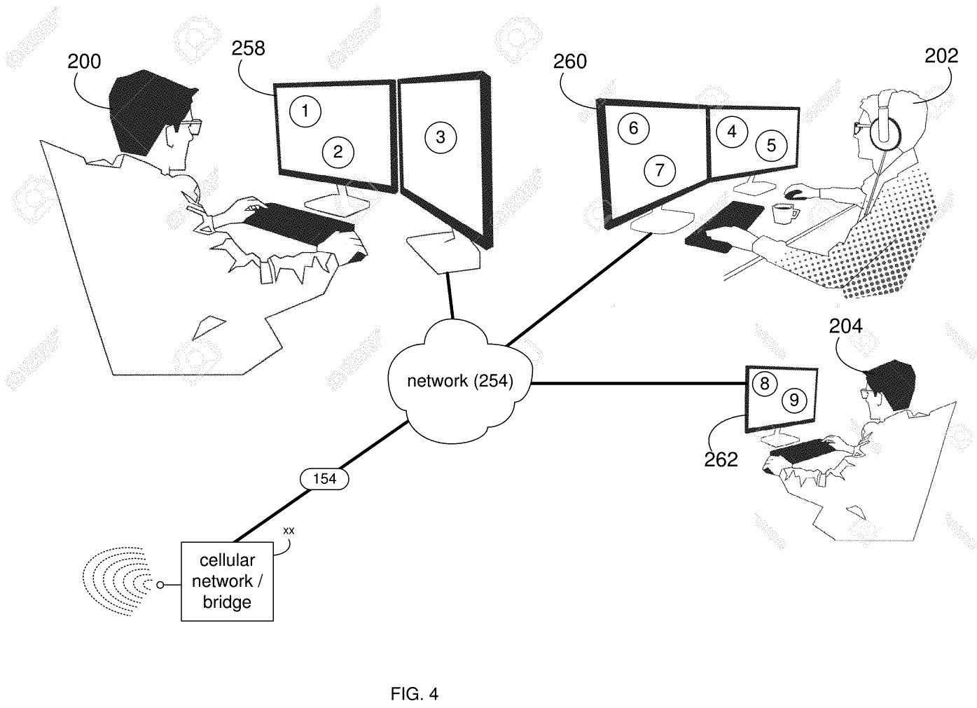

For example and referring also to FIG. 4, vehicle monitors (e.g., vehicle monitors 200, 202, 204) may be located in a centralized location (such as a remote monitoring and operation center) and may monitor the operation of various autonomous vehicles (e.g., autonomous vehicle 10). For example, vehicle monitors 200, 202, 204 may (in this example) be monitoring the operation of nine autonomous vehicles (e.g., autonomous vehicle #1 through autonomous vehicle #9), each of which is represented as a unique circle on the displays of vehicle monitors 200, 202, 204. Specifically and for this example, assume that vehicle monitor 200 is monitoring three autonomous vehicles (i.e., autonomous vehicles 1-3), vehicle monitor 202 is monitoring four autonomous vehicles (i.e., autonomous vehicles 4-7) and vehicle monitor 204 is monitoring two autonomous vehicles (i.e., autonomous vehicles 8-9).

Data Mapping

As discussed above, autonomous vehicle 10 may include a plurality of sensors (e.g. sensors 12), a plurality of electronic control units (e.g. ECUs 14) and a plurality of actuators (e.g. actuators 16). Accordingly, sensors 12 within autonomous vehicle 10 may monitor the environment in which autonomous vehicle 10 is operating, wherein sensors 12 may provide sensor data 18 to ECUs 14. ECUs 14 may process sensor data 18 to determine the manner in which autonomous vehicle 10 should move. ECUs 14 may then provide control data 20 to actuators 16 so that autonomous vehicle 10 may move in the manner decided by ECUs 14. Accordingly, sensors 12 within autonomous vehicle 10 may be configured to perceive the surroundings of autonomous vehicle 10, wherein examples of sensors 12 may include but are not limited to radar, computer vision, LIDAR, GPS, odometry, temperature and inertia, wherein such sensor systems may be configured to interpret lanes and markings on a roadway, street signs, stoplights, pedestrians, other vehicles, roadside objects, hazards, etc.

Accordingly, sensor data 18 generated by sensors 12 may concern agents and objects positioned proximate of autonomous vehicle 10, wherein sensor data 18 may be very numbers driven.

Accordingly and with respect to objects proximate autonomous vehicle 10, such objects may be tracked, wherein:

the location of autonomous vehicle 10 may be determined,

the location of proximate objects (with respect to autonomous vehicle 10) may be determined,

the distance of each proximate object (with respect to autonomous vehicle 10) may be measured,

the polar angle of each proximate object (with respect to autonomous vehicle 10) may be determined,

the velocity of each proximate object may be determined, and

the trajectory of each proximate object may be determined.

Unfortunately, sensor data 18 generated by sensors 12 may be extremely numbers-driven data (generally represented as metric data 152) that does not present well to (and is not easily understandable by) humans. Accordingly, autonomous vehicle 10 may execute mapping process 150, wherein mapping process 150 may be configured to process this numbers-driven data (e.g., metric data 152) produced (directly or indirectly) by sensors 12 to generate a semantic understanding (e.g., semantic understanding 154) of autonomous vehicle 10 (generally) and metric data 152 (specifically) that is more easily understandable by humans.

Mapping process 150 may be executed on a single ECU or may be executed collaboratively across multiple ECUs. For example, mapping process 150 may be executed solely by autonomy control unit 50, vehicle control unit 54 or vehicle control unit 74. Alternatively, cost calculation process 150 may be executed collaboratively across the combination of autonomy control unit 50, vehicle control unit 54 and vehicle control unit 74. Accordingly and in the latter configuration, in the event of a failure of one of autonomy control unit 50, vehicle control unit 54 or vehicle control unit 74, the surviving control unit(s) may continue to execute cost calculation process 150.

The instruction sets and subroutines of mapping process 150, which may be stored on storage device 156 coupled to ECUs 14, may be executed by one or more processors (not shown) and one or more memory architectures (not shown) included within ECUs 14. Examples of storage device 156 may include but are not limited to: a hard disk drive; a RAID device; a random access memory (RAM); a read-only memory (ROM); and all forms of flash memory storage devices.

Traditional vs. Symantec Understanding of Environment

Autonomous vehicles (e.g., autonomous vehicle 10) may be configured to operate in mixed traffic including other autonomous vehicles, human-operated vehicles, pedestrians, animals and other mobile objects. Traditionally, autonomous vehicles used the existing infrastructure that is built for human drivers and relied on a map of the surroundings of the autonomous vehicle in a metric way. For instance, the autonomous vehicle would attempt to place each object around the autonomous vehicle in an exact position described by a set of coordinates.

Unfortunately and in order to handle complex scenarios, autonomous vehicles may need to understand their surroundings and the intentions of other agents in their environment, wherein this understanding ideally should be semantic (i.e., described in a symbolic and relational form). For example, when another car is blocking passage down a road, the autonomous vehicle should understand that “the road is blocked by a car” in this semantic form (as opposed to raw sensor data that shows an obstruction in the road). Accordingly and in such a situation, an autonomous vehicle ideally should be capable of distinguishing between a car that is parked on the side of the road versus a car that is in the middle of the lane in a one-way road. According and in such a situation, the exact position of the blocking car matters less, while whether or not the road is blocked affects the decision making process of the autonomous vehicle.

Another example of semantic understanding as it applies to autonomous vehicles may include but is not limited to identifying the intentions of an agent (e.g., the prediction that “a person will cross the street.”). Further, more complex semantic understandings may be constructed as a combination of predictions. In a typical scenario, an autonomous vehicle may simultaneously consider tens (or hundreds) of semantic understandings in order to make critical decisions.

Generally speaking, a semantic understanding may include the following as its subjects:

Static Elements, such as roads, lanes, crosswalks, posts and signs; and

Dynamic Elements, such as vehicles, people, and animals.

Accordingly, a semantic understanding may be constructed via:

Spatial Relationships that describe static and/or dynamic elements with respect to each other regarding their location in a semantic manner. For example, “a car is on the road” spatially relates a “car” (a dynamic element) with a “road” (a static element), described in a semantic manner (using language and logic); and

Temporal Predictions that describe the future interaction of these static and/or dynamic elements. For example, “a person will cross the street” is a temporal prediction of a “person” (a dynamic element) traversing a “street” (a spatial element) at some time in the future, described in a semantic manner (using language and logic).

Generally speaking, semantic understanding of an environment is different from metric understanding of the environment. In a metric understanding of the environment, the autonomous vehicle may know the exact position of another car and the road. However and in a semantic understanding of the environment, the autonomous vehicle may know whether or not the current position of the other car is blocking the road. Traditional autonomous vehicle technologies relied on a metric understanding of the operating environment of the autonomous vehicle. For example, objects of interest (e.g., people and vehicles) may simply be represented by their Cartesian coordinates in a fixed coordinate frame attached to the autonomous vehicle.

However and with respect to the semantic understanding of the operating environment of the autonomous vehicle, the autonomous vehicle may understand when a person will likely cross a street and/or when another vehicle is blocking the lane, wherein this semantic understanding may shape the future decisions undertaken by the autonomous vehicle.

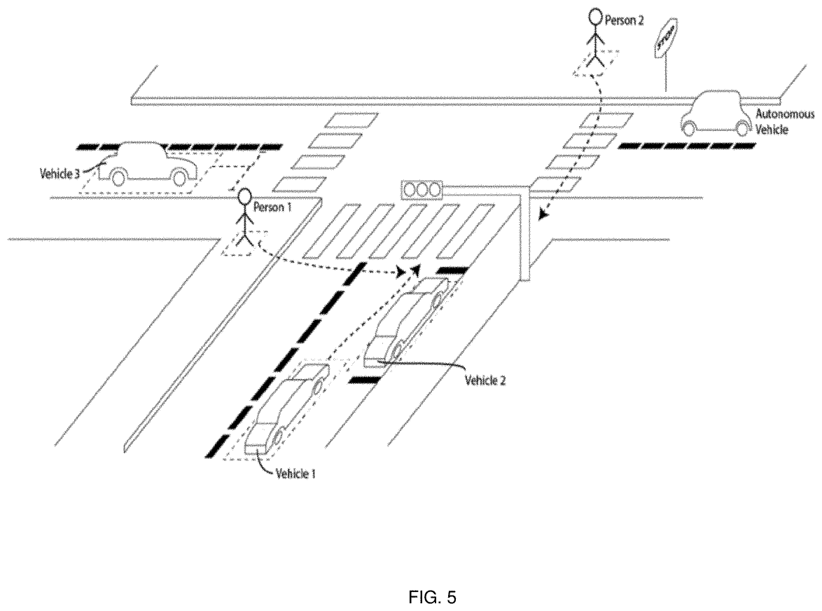

Referring also to FIG. 5, there is shown an autonomous vehicle stopped at an intersection, and the autonomous vehicle is interpreting its operating environment according to its semantic understanding.

Accordingly, the autonomous vehicle may be capable of understanding that:

Person 1 and Vehicle 1 will probably meet and Person 1 will probably get inside Vehicle 1.

Vehicle 2 is in a parking spot.

Person 2 will probably cross the street via a crosswalk.

Vehicle 3 will probably stop and wait.

Such a semantic understanding may be powerful, as it may allow the autonomous vehicle to make the following inferences decisions:

The autonomous vehicle must wait for Person 2 to cross to street before proceeding into the intersection.

If the autonomous vehicle needs to turn left, the autonomous vehicle must wait for Person 1 to cross to street.

Importantly, such a semantic understanding does rely on the precise cartesian coordinates of any of the agents. Conversely, this semantic understanding relies on logic and language to draw conclusions. In a real-world scenario, the autonomous vehicle may make hundreds of such inferences and decisions in real time.

Symantec Understanding of the Environment

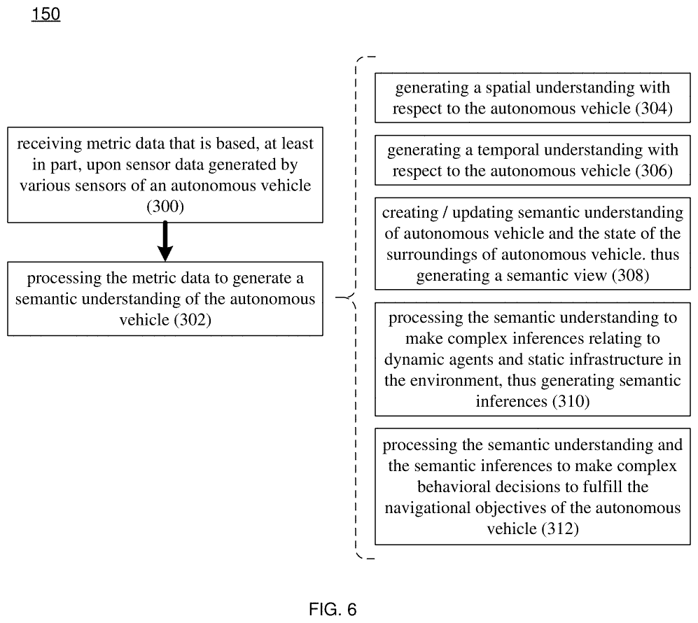

Referring also to FIG. 6, mapping process 150 may be configured to receive 300 metric data 152 that may be based, at least in part, upon sensor data 18. As discussed above, metric data 152 may be numbers-driven data, such as the raw sensor data that is provided by the various sensors (e.g., sensors 12) included within autonomous vehicle 10. As discussed above, examples of sensors 12 may include but are not limited to radar, computer vision, LIDAR, GPS, odometry, temperature and inertia sensors,

Mapping process 150 may be configured to process 302 this numbers-driven data (e.g., metric data 152) produced (directly or indirectly) by sensors 12 to generate a semantic understanding (e.g., semantic understanding 154) of autonomous vehicle 10 (generally) and metric data 152 (specifically) that is more easily understandable by humans.

Semantic understanding 154 may include (generally) two components: Spatial Understanding 158 and Temporal Understanding 160. Accordingly and when processing 302 metric data 152 produced (directly or indirectly) by sensors 12 to generate a semantic understanding (e.g., semantic understanding 154), mapping process 150 may generate 304 a spatial understanding (e.g., spatial understanding 158) with respect to autonomous vehicle 10 and/or may generate 306 a temporal understanding (e.g., temporal understanding 160) with respect to autonomous vehicle 10.

Spatial Understanding: The spatial understanding of autonomous vehicle 10 (generally) and metric data 152 (specifically) may relate to the understanding of agents and objects proximate autonomous vehicle 10 and their states that relate to their current locations. Spatial understanding 158 of the surroundings of autonomous vehicle 10 may be generated 304 by various algorithms (e.g., supervised machine learning) and by using raw exteroceptive sensory data (e.g., optical and thermal cameras, laser range finders (or LiDARs), radars, ultrasonic range finders, or other sensors with which autonomous vehicle 10 may obtain metric data 152 of its surroundings, for instance, in metric light exposure values in picture elements (pixels) on cameras, and metric range values in LiDARs, radars and ultrasonic range finders. For example, semantic segmentation algorithms may segment camera data into a predefined set of semantic labels, including people, vehicles, animals, and infrastructure elements, such as, roads, lanes, sidewalks, signage, and signaling.

Temporal Understanding: A temporal understanding of autonomous vehicle 10 (generally) and metric data 152 (specifically) may relate to its understanding of agents and objects regarding their future states. Temporal understanding 160 of the surroundings of autonomous vehicle 10 may be generated 306 by prediction algorithms (e.g., supervised, semi-supervised and/or self-supervised machine learning methods) that use e.g., semantic labels together with their temporal tracks obtained using visual or point-cloud tracking methods. For example, the metric location of a person may be tracked through an environment, and the future trajectory of the person may be predicted based upon context, location, motion, and visual cues from the person.

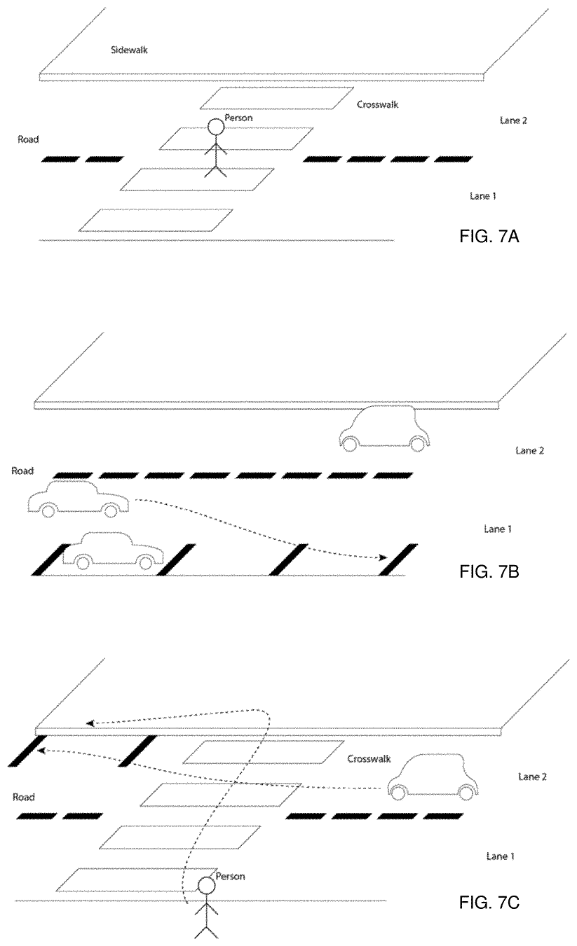

Spatial Understanding 158 of autonomous vehicle 10 may be materialized via semantic spatial relationships, wherein many complex cognitive decisions may be enabled by these semantic spatial relationships between dynamic agents (e.g., people and vehicles) and static infrastructure (e.g., roads and crosswalks). For example, the semantic spatial relationship “a person is on a crosswalk” (as shown in FIG. 7A) may require that autonomous vehicle 10 encountering this interaction exhibits a certain behavior to ensure legible, safe motion that does not frighten the person. In this case, autonomous vehicle 10 may slow down sooner to communicate its intent to stop. Conversely, when autonomous vehicle 10 stops for a traffic light and there is no person on the crosswalk, such slowing may be more abrupt.

Temporal Understanding 160 of autonomous vehicle 10 may be materialized via temporal predictions, wherein many complex cognitive decisions may be enabled by semantic temporal predictions involving potentially multiple dynamic agents (e.g., people and vehicles) and static infrastructure (e.g., roads and crosswalks). For example, the temporal prediction that “a human-operated vehicle is going to park at a certain parking spot” (as shown in FIG. 7B) may require that autonomous vehicle 10 encountering this interaction exhibits a certain behavior. For example, autonomous vehicle 10 may leave sufficient distance for the human-operated vehicle to be able the human-operated vehicle to get into the parking spot. Further, more complex temporal predictions may involve multiple dynamic agents and static infrastructure. For example, the temporal prediction “a person is going to get inside a human-operated vehicle in the lane across the street” (as shown in FIG. 7C) may require that autonomous vehicle 10 encountering this interaction exhibits a certain behavior (e.g., slowing down to ensure safety in the event that the person crosses the street to reach the vehicle).

Generally speaking, autonomous vehicle 10 may contextualize spatial semantic relationships and temporal predictions in order to make complex behavioral decisions, which human drivers, pedestrians and others sharing the road with autonomous vehicles (e.g., autonomous vehicle 10) expect such autonomous vehicles to make.

Accordingly and when processing 302 metric data 152 produced (directly or indirectly) by sensors 12 to generate a semantic understanding (e.g., semantic understanding 154), mapping process 150 may:

create/update 308 semantic understanding 154 of autonomous vehicle 10 and the state of the surroundings of autonomous vehicle 10 (thus generating Semantic View 164);

processing 310 semantic understanding 154 to make complex inferences relating to dynamic agents and static infrastructure in the environment, thus generating semantic inferences 162 (which may be referred to as the process of Semantic Inferencing, as will be explained below in greater detail); and

processing 312 semantic understanding 154 and semantic inferences 162 to make complex behavioral decisions to fulfill the navigational objectives of autonomous vehicle 10 while ensuring safety and efficiency (which may be referred to as the process of Semantic Behavior Planning, as will be explained below in greater detail).

Semantic Understanding Nomenclature

Static Infrastructure may include but is not limited to all static elements relevant to the task of autonomous vehicle 10 driving, examples of which may include but are not limited to: buildings, parks, garages, parking spaces, sidewalks, roads, vehicle lanes, bike lanes, special lanes, intersections, roundabouts, lane markings, road marking, signage, cones, and signaling.

Dynamic Agents may include but is not limited to all movable elements that may be in motion relevant to the task of autonomous vehicle 10 driving, examples of which may include but are not limited to: people, bicycles, vehicles, animals, as well as other dynamic objects in motion (e.g., balls, carts, and any objects falling from vehicles).

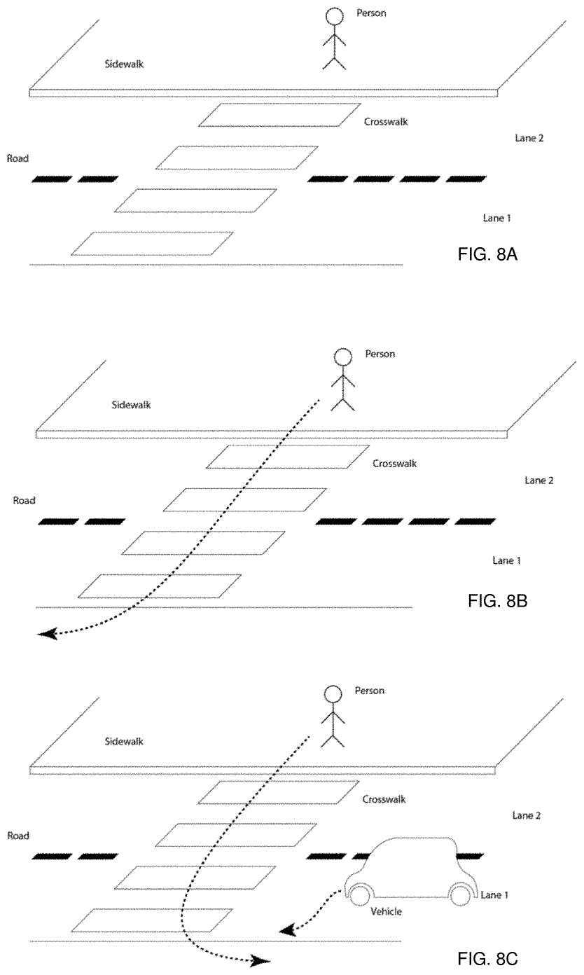

Spatial Relations may include but is not limited to the semantic relationships that relate to the relative location between any combination of Static Infrastructure and/or Dynamic Agents. For example, “a person is on a sidewalk” (as shown in FIG. 8A) describes the spatial relationship between the person (a dynamic agent) and a sidewalk (a static infrastructure).

Temporal Predictions may include but is not limited to the semantic relationships that relate to future semantic states of potentially multiple Dynamic Agents in relation to Static Infrastructure. Temporal predictions may include but is not limited to an encoding of uncertainty, in terms of probability, frequency and/or any other methods of uncertainty encoding. For example, “a person will cross the street via a crosswalk” (as shown in FIG. 8B) is a temporal prediction involving a person (a dynamic agent), a street (a static infrastructure) and a crosswalk (a static infrastructure). Other scenarios may involve multiple dynamic agents. For example, “a person and a vehicle will meet at a curb” (as shown in FIG. 8C) is a temporal prediction involving a person (a dynamic agent), a vehicle (a dynamic agent), and a curb (a static infrastructure).

The Semantic View

The above-described Semantic View (e.g., semantic view 164) may be a data structure system having a collection of dynamic generalized directed trees including:

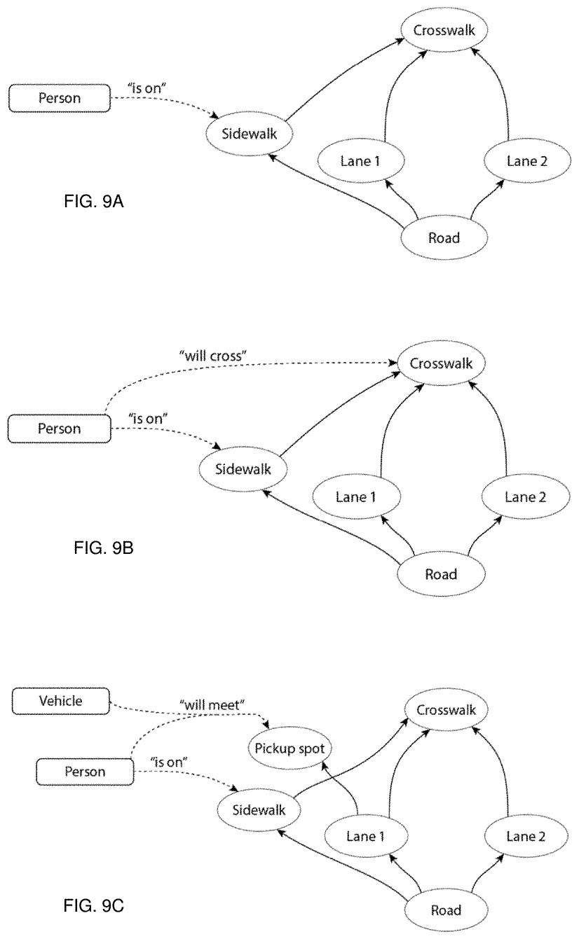

a Static Infrastructure Semantic View (e.g., a generalized directed tree) having a set of nodes that includes all static infrastructure elements. The generalized edges may represent all semantic spatial relationships between these static infrastructure elements, wherein the nature of the relationship may be indicated on the labels. For example, the static infrastructure semantic view for the scenario shown in FIG. 8A is shown in FIG. 9A.

a Dynamic Agent Semantic View (e.g., a generalized directed tree) having a set of nodes that includes (i) all nodes of the Static Infrastructure Semantic View and (ii) nodes for all dynamic agents. The set of generalized labeled edges may include:
1. spatial relations between dynamic agents and spatial infrastructure, where the edge is directed from the dynamic agent node to the spatial infrastructure node with the label encoding the nature of the relationship. For example, the dynamic agent semantic view for the scenario shown in FIG. 8B is shown in FIG. 9B
2. temporal predictions involving multiple dynamic agents and multiple static infrastructure, where the source nodes include all dynamic agents and the destination nodes include all static infrastructure. The labels denote the nature of the prediction. For example, the dynamic agent semantic view for the scenario shown in FIG. 8C is shown in FIG. 9C

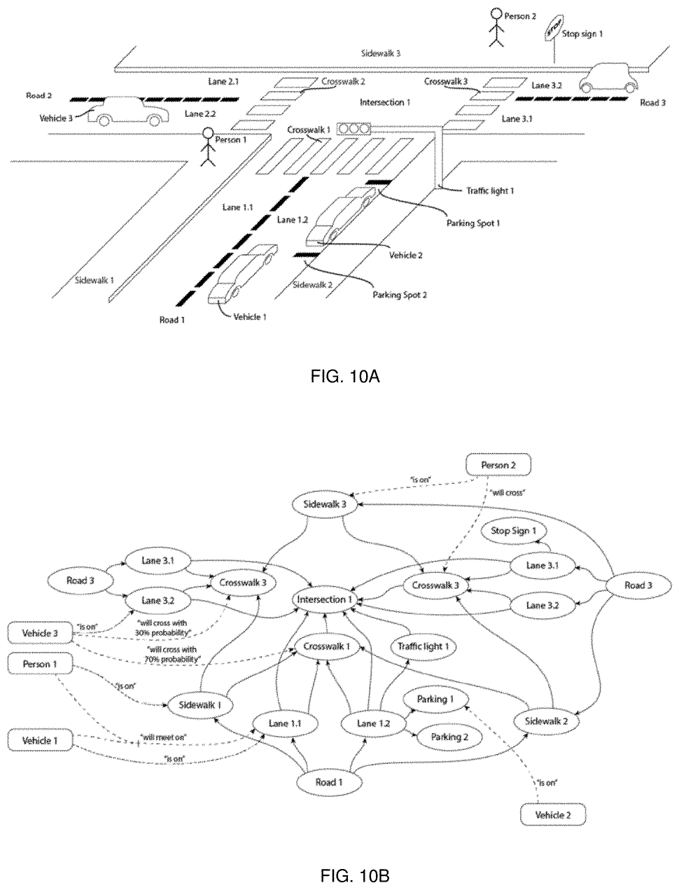

A sample environment encountered by an autonomous vehicle is shown in FIG. 10A, wherein this sample environment includes various static infrastructure elements, as well as spatial relations and temporal predictions involving various dynamic agents. The semantic view that corresponds to the environment of FIG. 10A is shown in FIG. 10B; wherein it is understood that the scenarios faced in typical operations of autonomous vehicle 10 may be several orders of magnitude larger than the examples depicted in FIGS. 10A-10B.

The Semantic View (e.g., semantic view 164) may be defined by the general semantic relationships involving (potentially multiple) dynamic agents and static infrastructures. Its implementation as a collection of dynamic generalized directed trees may be a general abstraction that supports the most detailed models by incorporating extensive data into the nodes and the labels in the system. The Semantic View (e.g., semantic view 164) may encode the salient properties of static infrastructure, such as their condition, color, type, category, and state as data in the node associated with that static infrastructure. All properties of static infrastructure that may change over time may be encoded as variables in the node data structure. For example, the state of a traffic light signal (e.g., green, yellow, or red) may be encoded in the node representing the corresponding static infrastructure (e.g., the traffic light signal) in the Static Infrastructure Semantic View.

The Semantic View (e.g., semantic view 164) may encode complex spatial relations between dynamic agents and static infrastructure. The nature of this relationship (however complex) may be encoded in the label of the generalized labeled edges, examples of which may include but are not limited to: the dynamic agent being on, adjacent to, at the center of, at the edge of, blocking, unblocking a static infrastructure, or any other attribute that describes the dynamic agent spatially with respect to the static infrastructure in a semantic manner. For example, a person being at the starting edge of and stepping into a crosswalk is encoded, using any complex data structure necessary, in the label for the corresponding generalized labeled edge of the Dynamic Agent Semantic View.

The Semantic View (e.g., semantic view 164) may encode complex temporal predictions involving multiple dynamic agents and multiple static infrastructure as in its encoding of complex relationships. The nature of this relationship (however complex) may be encoded in the label of the corresponding generalized labeled edge. Temporal predictions may include complex temporal predicates on potential future spatial relationships. For example, “a person will step on the crosswalk in the next 10 seconds with 90% certainty” indicates a complex temporal predicate involving metric time description, in this case “10 seconds,” together with a probabilistic predicate, in this case “with 90% certainty.” More complex temporal relationships may be constructed by involving multiple dynamic agents and multiple spatial infrastructure. Complex temporal relationships such as these may be stored in the label for the corresponding generalized labeled edge in the Dynamic Semantic View.

Mapping process 150 may update all data structures included within the Semantic View (e.g., semantic view 164) in run time in several ways, example of which may include but are not limited to:

based upon the output of perception algorithms that process real-time sensory data, such as, cameras, LiDARs, radars, ultrasonic range finders and/or any other exteroceptive data source;

based upon communication with other autonomous or human-operated vehicles;

based upon communication with any type of static or mobile infrastructure element; and

based upon input from human passengers, human operators and/or any other human participating providing input to the vehicle in any form.

Semantic Inferencing Method

As discussed above and with respect to the semantic inferencing process that will be described below, mapping process 150 may process 310 semantic understanding 154 to make complex inferences relating to dynamic agents and static infrastructure in the environment, thus generating semantic inferences 162 (which may be referred to as the semantic inferencing process).

Generally speaking, autonomous vehicles (e.g., autonomous vehicle 10) may understand how various spatial relationships and temporal predictions impact their current state and their future plans. Accordingly, the semantic inferencing process may search the Semantic View (e.g., semantic view 164) and may output a list of all dynamic agents and static infrastructure along with spatial and temporal predicates that affect the current state of autonomous vehicle 10, as well as its planned future trajectory and behavior.

For example and when mapping process 150 processes 310 semantic understanding 154 to make complex inferences relating to dynamic agents and static infrastructure in the environment, mapping process 150 may:

identify the location of autonomous vehicle 10 in the Static Infrastructure Semantic View by a pointer to a node of the Static Infrastructure Semantic View. This pointer may be referred to as the autonomous vehicle pointer. For example, if autonomous vehicle 10 is on a certain lane, the autonomous vehicle pointer may point to the node associated with that lane in the Static Infrastructure Semantic View.

search for directed labeled edges ending at the Static Infrastructure Semantic View node of the autonomous vehicle pointer. The set of such directed labeled edges may be called the autonomous vehicle relations.

identify:
1. The Static Infrastructure Relation Set: All other nodes in the Statistic Infrastructure Semantic View, where the directed labeled edges of the autonomous vehicle relations end, together with the corresponding labels of the said directed labeled edges;
2. The Dynamic Agent Relation Set: All nodes in the Dynamic Agent Semantic View, where the directed labeled edges of the autonomous vehicle relation start, together with the corresponding labels of the said directed labeled edges.

return the Static Infrastructure Relation Set and the Dynamic Agent Relation Set.

In the Static Infrastructure Relation Set and the Dynamic Infrastructure Relation Set, the Semantic Inferencing Method may rapidly identify:

All dynamic agents that the autonomous vehicle is semantically interacting with (or may semantically interact with in the future), which are encoded in the Static Infrastructure Relation Set.

All static infrastructure that this interaction is occurring (or will occur in the future), which are encoded in the nodes in the Dynamic Agent Relation Set.

The nature of such interactions, which are encoded in the labels contained in both the Static Infrastructure Relation Set and the Dynamic Agent Relation Set.

The Semantic Inferencing Method may be executed for a certain number of children nodes of the autonomous vehicle pointer node in the Static Infrastructure View. For example, if the vehicle is within a certain parking spot, which is on a certain lane, which is on a certain road, then the Semantic Inferencing Method may be executed on all of these infrastructure nodes and return its output using all such nodes for their starting point. Accordingly, the Semantic Inferencing Method may return a broader view of the semantic relations that affect autonomous vehicle 10.

The Semantic Inferencing Method may be executed on a future semantic trajectory of autonomous vehicle 10. In this case, the future semantic trajectory may be identified by a list of nodes that autonomous vehicle 10 plans to traverse. The Semantic Inferencing Method may then be applied that considers all such nodes as the autonomous vehicle pointer. In this case, the Semantic Inferencing Method may be implemented in more efficient ways, such as; by maintaining an efficient list implemented e.g., as a hash table that contains all static infrastructure nodes and all dynamic agent nodes, so that they are not processed multiple times.

Semantic Behavior Planning Method

As discussed above and with respect to the semantic behavior planning process that will be described below, mapping process 150 may process 312 semantic understanding 154 and semantic inferences 162 to make complex behavioral decisions to fulfill the navigational objectives of autonomous vehicle 10 while ensuring safety and efficiency (which may be referred to as the semantic behavior planning process).

Generally speaking, autonomous vehicle 10 may make decisions that respond to various complex spatial relationships and temporal predictions. These decisions are typically behavioral, wherein they may impose a certain set of constraints, within which the typical metric planning methods may choose a specific plan. These behaviors may be set at the semantic level. For planning purposes, an additional data structure (e.g., a Static Infrastructure Traversal Transition System) may be required. This data structure (e.g., a Static Infrastructure Traversal Transition System) may be a transition system, where:

The states are nodes chosen from the nodes in the Static Infrastructure Semantic View; and

The transitions exist from one state to another if autonomous vehicle 10 can traverse the corresponding static infrastructure elements that the nodes represent.

The Static Infrastructure Traversal Transition System may be created offline together with the infrastructure. However, it may be updated online e.g., to indicate new transitions and/or blocked transitions, via information obtained from sensors or via communication with other vehicles or infrastructure.

The Semantic Behavior Planning Method may be a semantic meta-planning method that uses the Semantic View (e.g., semantic view 164) to decide behaviors that autonomous vehicle 10 may follow. Accordingly and when mapping process 150 process 312 semantic understanding 154 and semantic inferences 162 to make complex behavioral decisions to fulfill the navigational objectives of autonomous vehicle 10 while ensuring safety and efficiency, mapping process 150 may generate a Labeled Markov Decision Process using the Semantic View.

For example, mapping process 150 may:

create a Markov Decision Process such that:
1. the set of states are composed of:
   a. one state variable indicating the spatial state of autonomous vehicle 10, which may take its values from the states of the Static Infrastructure Traversal Transition System;
   b. one state variable indicating the semantic state of autonomous vehicle 10, such as: parked, stopped, accelerating, accelerating rapidly, moving slow, moving at operational speed, braking at operational deceleration, and braking very rapidly;
   c. one state variable for each of the dynamic agents indicating the spatial state of that dynamic agent, represented as a probability distribution over the set of all nodes that the dynamic agent may traverse on the Static Infrastructure Semantic View; and
   d. one state variable for each of the dynamic agents indicating the semantic state of that dynamic agent, represented as a probability distribution over the set of semantic states, values of which depend on the type of dynamic agent and their attributes.
2. The actions may include all potential actions of autonomous vehicle 10 in traversing the Static Infrastructure Traversal Transition System. For each transition in the Static Infrastructure Traversal Transition System, there exists a corresponding action in the Markov Decision Process of the Semantic Behavior Planning Method, wherein the starting state and the ending state in the Markov Decision Process are the corresponding starting state and the ending states in the Static Infrastructure Traversal Transition System.
3. The transition probabilities may be calculated by the temporal predictions stored in the labels of the corresponding directed labeled edges of the Dynamic Agent Semantic View. The calculations may be specific to the particular representations. The resulting transition probabilities may indicate the new spatial state and the new semantic state of the corresponding dynamic agent, depending on the temporal prediction and the specific action chosen by autonomous vehicle 10.

generate sets of actions, which represent the allowable semantic behaviors, by searching the Markov Decision Process for risk of reaching undesired semantic states. The undesired semantic states may typically be specified a priori. For instance, an undesired behavior is autonomous vehicle 10 speeding up when approaching a crosswalk that a pedestrian will be crossing in the near future. The method identifies such cases and disallows them by excluding them from the sets of actions that encode the semantic behaviors.

group the set of all allowable actions with respect to their degree of spatial and temporal relation, as described by how close they are in the Semantic View (e.g., semantic view 164) e.g., by the number of consecutive nodes that connect them. In this manner, the behaviors are spatially and temporally localized.

output the resulting Labeled Markov Decision Process along with a set of behaviors encoded as sets of actions.

As discussed above, autonomous vehicle 10 may execute mapping process 150, wherein mapping process 150 may be configured to process metric data 152 produced (directly or indirectly) by sensors 12 to generate semantic understanding 154 of autonomous vehicle 10 (generally) and metric data 152 (specifically) that is more easily understandable by humans. Accordingly and once semantic understanding 154 is generated by mapping process 150, semantic understanding 154 may be provided to various entities in various fashions. For example:

semantic understanding 154 may be provided to a rider (e.g., rider 166) within autonomous vehicle 10 as rendered text on display device 168 that is within visual proximity of rider 166. For example, mapping process 150 may render on display device 168 the visual message “We are currently stopped, as the roadway is blocked”.

semantic understanding 154 may be provided to a rider (e.g., rider 166) within autonomous vehicle 10 as synthesized speech via audio rendering device 170 that is within audible proximity of rider 166. For example, mapping process 150 may render on audio rendering device 170 the audible message “We are currently stopped, as the roadway is blocked”.

Additionally, semantic understanding 154 may be provided to one or more remote entities. As discussed above, vehicle monitors (e.g., vehicle monitors 200, 202, 204) may be located in a centralized location (such as a remote monitoring and operation center) and may monitor the operation of various autonomous vehicles (e.g., autonomous vehicle 10). Accordingly, semantic understanding 154 may be wirelessly transmitted to the remote monitoring and operation center where vehicle monitors 200, 202, 204 reside. Once received:

semantic understanding 154 may be provided to a vehicle monitor (e.g., vehicle monitors 200, 202, 204) within the remote monitoring and operation center as rendered text on a client electronic device (e.g., client electronic device 258, 260, 262) utilized by vehicle monitors 200, 202, 204 (respectively). For example, mapping process 150 may render on one or more of client electronic devices 258, 260, 262 the visual message “Autonomous Vehicle 2613L is currently stopped, as the roadway is blocked”.

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implement method, executed on a computing device, comprising:
receiving metric data that is based, at least in part, upon sensor data generated by various sensors of an autonomous vehicle; and
processing the metric data to generate a semantic understanding of the autonomous vehicle.

2. The computer-implement method of claim 1 wherein processing the metric data to generate a semantic understanding of the autonomous vehicle includes:
generating a spatial understanding with respect to the autonomous vehicle.

3. The computer-implement method of claim 1 wherein processing the metric data to generate a semantic understanding of the autonomous vehicle includes:
generating a temporal understanding with respect to the autonomous vehicle.

4. The computer-implement method of claim 1 wherein processing the metric data to generate a semantic understanding of the autonomous vehicle includes:
creating/updating a semantic understanding of the autonomous vehicle and the state of the surroundings of the autonomous vehicle. thus generating a semantic view.

5. The computer-implement method of claim 4 wherein processing the metric data to generate a semantic understanding of the autonomous vehicle further includes:
processing the semantic understanding to make complex inferences relating to dynamic agents and static infrastructure in the environment, thus generating semantic inferences.

6. The computer-implement method of claim 5 wherein processing the metric data to generate a semantic understanding of the autonomous vehicle further includes:
processing the semantic understanding and the semantic inferences to make complex behavioral decisions to fulfill the navigational objectives of the autonomous vehicle.

7. The computer-implement method of claim 4 wherein the semantic view includes one or more of:
a static infrastructure semantic view having a set of nodes that includes all static infrastructure elements; and
a dynamic agent semantic view having a set of nodes that includes:
all nodes of the static infrastructure semantic view, and
nodes for all dynamic agents.

8. A computer program product residing on a computer readable medium having a plurality of instructions stored thereon which, when executed by a processor, cause the processor to perform operations comprising:
receiving metric data that is based, at least in part, upon sensor data generated by various sensors of an autonomous vehicle; and
processing the metric data to generate a semantic understanding of the autonomous vehicle.

9. The computer program product of claim 8 wherein processing the metric data to generate a semantic understanding of the autonomous vehicle includes:
generating a spatial understanding with respect to the autonomous vehicle.

10. The computer program product of claim 8 wherein processing the metric data to generate a semantic understanding of the autonomous vehicle includes:
generating a temporal understanding with respect to the autonomous vehicle.

11. The computer program product of claim 8 wherein processing the metric data to generate a semantic understanding of the autonomous vehicle includes:
creating/updating a semantic understanding of the autonomous vehicle and the state of the surroundings of the autonomous vehicle. thus generating a semantic view.

12. The computer program product of claim 11 wherein processing the metric data to generate a semantic understanding of the autonomous vehicle further includes:
processing the semantic understanding to make complex inferences relating to dynamic agents and static infrastructure in the environment, thus generating semantic inferences.

13. The computer program product of claim 12 wherein processing the metric data to generate a semantic understanding of the autonomous vehicle further includes:
processing the semantic understanding and the semantic inferences to make complex behavioral decisions to fulfill the navigational objectives of the autonomous vehicle.

14. The computer program product of claim 11 wherein the semantic view includes one or more of:
a static infrastructure semantic view having a set of nodes that includes all static infrastructure elements; and
a dynamic agent semantic view having a set of nodes that includes:
all nodes of the static infrastructure semantic view, and
nodes for all dynamic agents.

15. A computing system including a processor and memory configured to perform operations comprising:
receiving metric data that is based, at least in part, upon sensor data generated by various sensors of an autonomous vehicle; and
processing the metric data to generate a semantic understanding of the autonomous vehicle.

16. The computing system of claim 15 wherein processing the metric data to generate a semantic understanding of the autonomous vehicle includes:
generating a spatial understanding with respect to the autonomous vehicle.

17. The computing system of claim 15 wherein processing the metric data to generate a semantic understanding of the autonomous vehicle includes:
generating a temporal understanding with respect to the autonomous vehicle.

18. The computing system of claim 15 wherein processing the metric data to generate a semantic understanding of the autonomous vehicle includes:
creating/updating a semantic understanding of the autonomous vehicle and the state of the surroundings of the autonomous vehicle. thus generating a semantic view.

19. The computing system of claim 18 wherein processing the metric data to generate a semantic understanding of the autonomous vehicle further includes:
processing the semantic understanding to make complex inferences relating to dynamic agents and static infrastructure in the environment, thus generating semantic inferences.

20. The computing system of claim 19 wherein processing the metric data to generate a semantic understanding of the autonomous vehicle further includes:
processing the semantic understanding and the semantic inferences to make complex behavioral decisions to fulfill the navigational objectives of the autonomous vehicle.

21. The computing system of claim 18 wherein the semantic view includes one or more of:
a static infrastructure semantic view having a set of nodes that includes all static infrastructure elements; and
a dynamic agent semantic view having a set of nodes that includes:
all nodes of the static infrastructure semantic view, and
nodes for all dynamic agents.
